(19) United States
(12) Patent Application Publication
(10) Pub. No.: US 2006/0130080 A1
(43) Pub. Date: Jun. 15, 2006

(54) Disc changer and disc loading device thereof

(75) Inventor: Tsung-Jung Kuo, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/235,340

(22) Filed: Sep. 27, 2005

(30) Foreign Application Priority Data
Dec. 9, 2004 (TW) 93138182

(51) Int. Cl. G11B 17/04

(52) U.S. Cl. 720/619

(57) ABSTRACT

A disc changer and the disc loading device thereof are provided. The disc changer has a guide rail, a storage portion and a read portion. The guide rail is disposed in parallel to a lateral side of the read portion. The disc loading device includes a driven bar, a gear plate and a drawbar body. The driven bar has a drawbar guide hole and a gear plate guide hole. The drawbar guide hole has a first end and a second end. The gear plate has a gear plate slide portion, which protrudes from the gear plate and passes through the gear plate guide hole. The drawbar body slideably received in the guide rail has a drag hook and a protrusion. The protrusion is slideably received in the drawbar guide hole.

This application claims the benefit of Taiwan application Serial No. 93138182, filed Dec. 9, 2004, the subject matter of which is incorporated herein by reference.

### BACKGROUND OF THE INVENTION

1. Field of the Invention

The invention relates in general to a disc loading device, and more particularly to a disc loading device applied in a disc changer.

2. Description of the Related Art

As modern people's are requesting higher and higher quality of life, the design of electronic products need to be adjusted in order to meet the consumers' increasing needs of quality. For example, the disc changer provides the consumers with more convenience and more choices in terms of audio entertainment. In the absence of a disc changer, the consumer has to unload the CD from the disc drive first and then load a selected CD into the disc drive. This is indeed very inconvenient to the user. Especially, it is very dangerous for a user to change a CD while driving. Therefore, apart from being used in a family Hi-Fi stereo system, the disc changer is also widely used in various vehicles. The driver can be focused on driving without being distracted by the change of CD.

The disc changer includes a read portion and a storage portion. The storage portion stores several discs for the read portion to access. The disc loading device positioned in the read portion moves the disc stored in the storage portion to the read portion to be read and played. However, the current disc loading device is not easy to be manufactured and assembled and would take more cost and time, affecting the competitiveness of the business.

### SUMMARY OF THE INVENTION

It is therefore an object of the invention to provide a disc loading device of a disc changer. The device is easy to be assembled and manufactured, so that the manufacturing cost of the disc changer is reduced and that the competitiveness of the business is increased.

The invention achieves the above-identified object by providing a disc loading device disposed in a disc changer. The disc changer has a guide rail, a storage portion and a read portion. The guide rail is disposed in parallel to a lateral side of the read portion. The disc loading device includes a driven bar, a gear plate and a drawbar body. The driven bar has a drawbar guide hole and a gear plate guide hole. The drawbar guide hole has a first end and a second end. The gear plate has a gear plate slide portion, which protrudes from the gear plate and passes through the gear plate guide hole. The drawbar body slideably received in the guide rail has a drag hook and a protrusion. The protrusion is slideably received in the drawbar guide hole. When the gear plate rotates, the gear plate slide portion slides along the gear plate guide hole and drives the driven bar to rotate. When the driven bar rotates, the driven bar drives the drawbar body to slide along the guide rail and in parallel to the lateral side by means of pressing the protrusion against the drawbar guide hole so that the drag hook drags the tray to the read portion from the storage portion of the disc changer.

The invention achieves the above-identified object by providing a disc changer including a read portion, a disc loading device, a guide rail and a storage portion. The disc loading device disposed in the read portion includes a driven bar, a gear plate and a drawbar body. The driven bar has a drawbar guide hole and a gear plate guide hole. The drawbar guide hole has a first end and a second end. The gear plate has a gear plate slide portion, which protrudes from the gear plate and passes through the gear plate guide hole. The drawbar body slideably received in the guide rail has a drag hook and a protrusion. The protrusion is slideably received in the drawbar guide hole. The guide rail is disposed in parallel to a lateral side of the read portion. The storage portion is adjacent to the read portion. When the gear plate rotates, the gear plate slide portion slides along the gear plate guide hole and drives the driven bar to rotate. When the driven bar rotates, the driven bar drives the drawbar body to slide along the guide rail and in parallel to the lateral side by means of pressing the protrusion against the drawbar guide hole so that the drag hook drags the tray to the read portion from the storage portion of the disc changer.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a perspective diagram of a disc changer according to a preferred embodiment of the invention;

FIG. 2A is an exploded diagram of the disc loading device of FIG. 1;

FIG. 2B is a top view of the read portion of FIG. 1; and

FIG. 2C is an enlarged diagram of a gear plate guide hole.

### DETAILED DESCRIPTION OF THE INVENTION

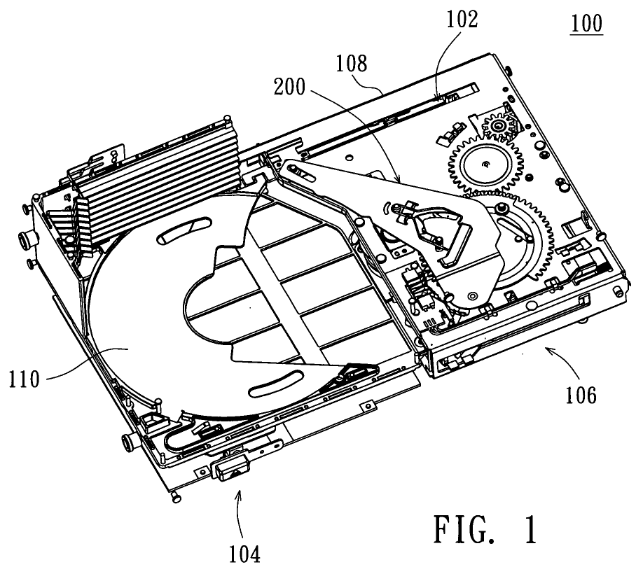

Referring to FIG. 1, a perspective diagram of a disc changer according to a preferred embodiment of the invention is shown wherein the case is removed. Disc changer 100 includes a guide rail 102, a storage portion 104 and a read portion 106. The storage portion 104 is adjacent to the read portion 106. The guide rail 102 is disposed in parallel to a lateral side 108 of the read portion 106. The storage portion 104 has at least a tray 110. The tray 110 stored in the storage portion 104 is used for placing a disc (not shown in the diagram). The read portion 106 has a disc loading device 200 capable of dragging the tray 110 from the storage portion 104 to the read portion 106 for reading the data of the disc placed on the tray 110.

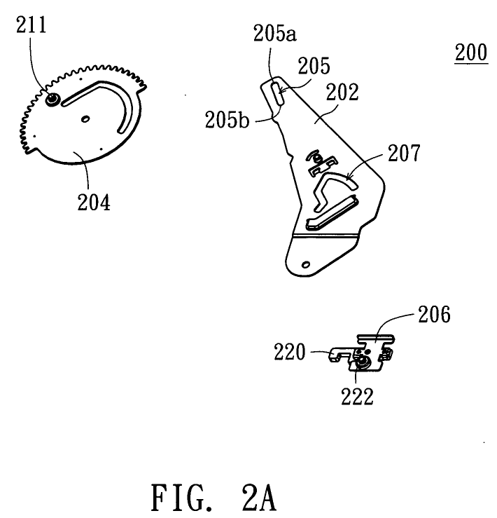

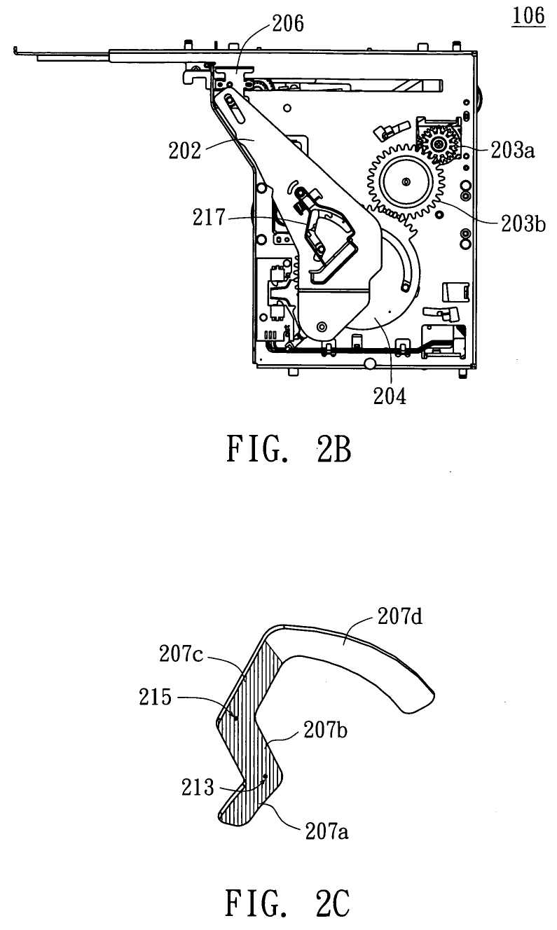

Referring to both FIG. 1 and FIG. 2A at the same time, FIG. 2A is an exploded diagram of the disc loading device of FIG. 1. Disc loading device 200 disposed in disc changer 100 includes a driven bar 202, a gear plate 204 and a drawbar body 206. The driven bar 202 has a drawbar guide hole 205 and a gear plate guide hole 207. The drawbar guide hole 205 has a first end 205a and a second end 205b. The gear plate 204 has a gear plate slide portion 211, which protrudes to be disposed on gear plate 204 and passes through the gear plate guide hole 207. The drawbar body 206 slideably received in the guide rail 102 has a drag hook 220 and a protrusion 222. The protrusion 222 is slideably received in the drawbar guide hole 205. The gear plate slide portion 211 rotates and slides along the gear plate guide hole 207 and drives the driven bar 202 to rotate when the gear plate 204 rotates. When driven bar 202 rotates, the driven bar 202 drives the drawbar body 206 to slide along the guide rail 102 and in parallel to the lateral side 108 by means of pressing the protrusion 222 against the drawbar guide hole 205 so that the drag hook 220 drags the tray 110 to the read portion 106 from the storage portion of the disc changer 104. The drag hook 220 contacts the tray 110 stored in the storage portion 104. The drag hook 220 can be made of plastics to prevent the tray 110 or the disc from being damaged due to vibration, and the drawbar body 206 can be made of a metal plate to reduce the manufacturing time.

Referring to both FIG. 2B, FIG. 2C at the same time. FIG. 2B is a top view of the read portion of FIG. 1, while FIG. 2C is an enlarged diagram of a gear plate guide hole. The gear plate guide hole 207 includes a direct line 207a, a first arc 207b, a second arc 207c and a third arc 207d. The first arc 207b is deflected and connected to the direct line 207a to form a first turning point 213. The second arc 207c is deflected and connected to the first arc 207b to form a second turning point 215. As shown in FIG. 2B, the read portion 106 has a driving gear 203a and an idle wheel 203b. The driving gear 203a is powered to rotate. The idle wheel 203b contacts the driving gear 203a and enables the gear plate 204 to rotate. The driven bar 202 and the drawbar body 206 are in a static state when the gear plate 204 starts to rotate clockwise and the gear plate slide portion 211 is positioned in the direct line 207a. When the gear plate slide portion 211 passes through the first turning point 213, the gear plate slide portion 211 presses against the first arc 207b of the driven bar 202 and drives the driven bar 202 to rotate clockwise. The driven bar 202 drives the drawbar body 206 to slide in parallel to a lateral side 108, meanwhile, the protrusion 222 moves correspondingly to the driven bar 202 from the first end 205a towards the second end 205b. When the gear plate slide portion 211 passes through the second turning point 215, the driven bar 202 still rotates clockwise and drives the drawbar body 206 to slide in parallel to the lateral side 108, meanwhile, the protrusion 222 moves correspondingly to the driven bar 202 from the second end 205b towards the first end 205a. As shown in FIG. 2B, the driven bar 202 further has a pre-stressing force spring 217 disposed on the driven bar 202 along the first arc 207b and the second arc 207c to provide a pre-stressing force enabling the gear plate slide portion 211 to slide smoothly along the gear plate guide hole 207. When the gear plate slide portion 211 enters the third arc 207d, the drawbar body has been moved to be at the right end of the guide rail 102. That is, the tray 110 has been moved to the read portion 106 from the storage portion 104. Therefore, the gear plate slide portion 211 does not drive the driven bar 202 to rotate during the third arc 207d, that is, the work in the third arc 207d is empty.

According to the disc changer disclosed in the above embodiment of the invention, the driven bar can be directly received in the gear plate and the drawbar body, and can slide according to the gear plate guide hole. The drawbar body slides along the guide rail when dragged by the driven bar. The movement in the design is also made simpler and easier. The assembly and manufacturing of the disc changer are made much easier according to the invention, so that the manufacturing time and cost of the disc changer are reduced and that the competitiveness of the business is increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A disc loading device disposed in a disc changer, wherein the disc changer has a guide rail, a storage portion used for storing a plurality of trays, and a read portion, and the guide rail is disposed in parallel to a lateral side of the read portion, wherein the device comprises:
a driven bar having a drawbar guide hole and a gear plate guide hole, wherein the drawbar guide hole has a first end and a second end;
a gear plate having a gear plate slide portion, wherein the gear plate slide portion protrudes from the gear plate and passes through the gear plate guide hole; and
a drawbar body slideably received in the guide rail, wherein the drawbar body has a drag hook and a protrusion, and the protrusion is slideably received in the drawbar guide hole;
wherein when the gear plate rotates, the gear plate slide portion slides along the gear plate guide hole and drives the driven bar to rotate;
wherein when the driven bar rotates, the driven bar drives the drawbar body to slide along the guide rail and in parallel to the lateral side by means of pressing the protrusion against the drawbar guide hole so that the drag hook drags the tray to the read portion from the storage portion of the disc changer.

2. The device according to claim 1, wherein the gear plate guide hole of the driven bar comprises:
a direct line;
a first arc deflected and connected to the direct line to form a first turning point;
a second arc deflected and connected to the first arc to form a second turning point;
wherein when the gear plate slide portion is positioned in the direct line, the driven bar and the drawbar body are at a static state;
wherein when the gear plate slide portion passes through the first turning point, the gear plate slide portion presses against the first arc of the driven bar and drives the driven bar to rotate, the driven bar then drives the drawbar body to slide in parallel to the lateral side; meanwhile, the protrusion moves correspondingly to the driven bar from the first end towards the second end;
wherein when the gear plate slide portion passes through the second turning point, the driven bar still rotates, the driven bar drives the drawbar body to slide in parallel to the lateral side; meanwhile, the protrusion moves correspondingly to the driven bar from the second end towards the first end.

3. The device according to claim 2, wherein the gear plate guide hole further comprises a third arc, and the driven bar and the drawbar body are at a static state and the drawbar body is positioned at the right end of the guide rail when the gear plate slide portion enters the third arc.

4. The device according to claim 1, wherein the drag hook of the drawbar body is made of plastics.

5. The device according to claim 1, wherein the drawbar body is made of a metal plate.

6. The device according to claim 1, wherein the driven bar further comprises a pre-stressing force spring.

7. The device according to claim 2, wherein the driven bar further comprises a pre-stressing force spring, and the pre-stressing force spring is disposed on the driven bar along the first arc and the second arc to provide a pre-stressing force for the gear plate slide portion to slide along the gear plate guide hole.

8. A disc changer, comprising:
a read portion;
a storage portion, which is adjacent to the read portion and is used for storing a plurality of trays;
a guide rail disposed in parallel to a lateral side of the read portion; and
a disc loading device disposed in the read portion, wherein the disc loading device comprises:
a driven bar having a drawbar guide hole and a gear plate guide hole, wherein the drawbar guide hole has a first end and a second end;
a gear plate having a gear plate slide portion, wherein the gear plate slide portion protrudes from the gear plate and passes through the gear plate guide hole; and
a drawbar body slideably received in the guide rail, wherein the drawbar body has a drag hook and a protrusion, and the protrusion is slideably received in the drawbar guide hole;
wherein when the gear plate rotates the gear plate slide portion slides along the gear plate guide hole and drives the driven bar to rotate;
wherein when the driven bar rotates, the driven bar drives the drawbar body to slide along the guide rail and in parallel to the lateral side by means of pressing the protrusion against the drawbar guide hole so that the drag hook drags the tray to the read portion from the storage portion of the disc changer.

9. The disc changer according to claim 8, wherein the gear plate guide hole of the driven bar comprises:
a direct line;
a first arc deflected and connected to the direct line to form a first turning point;
a second arc deflected and connected to the first arc to form a second turning point;
wherein when the gear plate slide portion is positioned in the direct line, the driven bar and the drawbar body are at a static state;
wherein when the gear plate slide portion passes through the first turning point, the gear plate slide portion presses against the first arc of the driven bar and drives the driven bar to rotate, the driven bar then drives the drawbar body to slide in parallel to the lateral side; meanwhile, the protrusion moves correspondingly to the driven bar from the first end towards the second end;
wherein when the gear plate slide portion passes through the second turning point, the driven bar still rotates, the driven bar drives the drawbar body to slide in parallel to the lateral side; meanwhile, the protrusion moves correspondingly to the driven bar from the second end towards the first end.

10. The disc changer according to claim 9, wherein the gear plate guide hole further comprises a third arc, and the driven bar and the drawbar body are at a static state and the drawbar body is positioned at the right end of the guide rail when the gear plate slide portion enters the third arc.

11. The disc changer according to claim 8, wherein the drag hook of the drawbar body is made of plastics.

12. The disc changer according to claim 8, wherein the drawbar body is made of a metal plate.

13. The disc changer according to claim 8, wherein the driven bar further comprises a pre-stressing force spring.

14. The disc changer according to claim 9, wherein the driven bar further comprises a pre-stressing force spring, and the pre-stressing force spring is disposed on the driven bar along the first arc and the second arc to provide a pre-stressing force for the gear plate slide portion to slide along the gear plate guide hole.
